(19) United States
(12) Patent Application Publication
(10) Pub. No.: US 2003/0182808 A1
(43) Pub. Date: Oct. 2, 2003

(54) V-cut knife for cutting crops and method of use thereof

(76) Inventors: Ruben P. Mireles SR., Lemoore, CA (US); Ruben P. Mireles JR., Lemoore, CA (US); Eric Mireles, Lemoore, CA (US)

Correspondence Address: Richard A. Ryan, RYAN & ENGNATH, Suite 104, 8469 N. Millbrook, Fresno, CA, 93720, US

(21) Appl. No.: 10/107,685

(22) Filed: Mar. 26, 2002

(51) Int. Cl. B26B 9/00

(52) U.S. Cl. 30/346

(57) ABSTRACT

The v-cut knife of the present invention has a handle connected to a blade section comprising a blade with a proximal end, a distal end, a top surface and a bottom surface. The bottom surface is formed into a sharp cutting edge. A generally v-shaped section is disposed between the proximal and distal ends of the blade. The v-shaped section is shaped and configured to cut away a waste portion of a plant from the useful produce portion. The knife is particularly useful for cutting the tail portion of a Romaine lettuce plant so as to maximize the amount of produce portion remaining after removing the waste core portion of the plant. When configured as described herein, the knife efficiently and safely cuts the tail section of a Romaine plant so as to leave as much produce behind as possible.

### BACKGROUND OF THE INVENTION

1. Field of the Invention

The field of the present invention relates generally to devices for cutting crops to separate the useful part of the crop from the waste portion of the crop. More specifically, the present invention relates to such cutting devices that are shaped and configured to permit quick and easy cutting away of the waste portion of crops while minimizing loss of useful produce. Even more specifically, the present invention relates to knives and the like that are useful for coring and trimming crops such as lettuce.

2. Background

As is well known, most crops that are grown for human consumption have a portion of the produced crop that is the useful portion and other portions that are not useful. The useful portion of the crop (i.e., the “produce”) is typically the part of the plant that is the preferred edible portion of the crop. Because the non-useful portion of the plant is typically not eaten by humans, it is generally considered waste (at least relative to the produce portion that is most often eaten by humans). Depending on the particular crop, the waste portion of the crop may be roots, stems, leaves, skin or various internal sections of the plant. Depending on the particular horticultural practices, the waste portion of the crop may be left in the field and recycled back into the soil to provide nutrients for the following years crop growth.

For some produce, such as bananas, citrus, watermelon, and others, at least a part of the waste portion of the crop is not separated until it reaches the consumer, who removes the waste portion just prior to eating the useful portion of the produce. For other crops, much of the waste portion is removed in the field during the harvest process. In fact, the actual process of harvesting many crops results in at least some of the waste portion being separated from the useful produce portion of the crop by the mere act of removing it from the tree, field, vine, bush or other growing plant medium. Certain other crops, such as lettuce and various bulb crops (such as onions, beets, radishes, turnips and the like) go through a multiple stage process where the crop is first extracted from the field and then waste material is removed from the produce portion of the crop. The field extraction separates the crop from most of its root section. Although it may be done by hand, the extraction of these crops from the field is typically (at least more modernly) performed by a harvesting apparatus to reduce the costs of harvesting. Any remaining roots or leaves are removed from the crop, either by the harvesting apparatus itself or by persons working in the field. Bulb crops, due to their “hard” nature, are typically more adaptable for the use of machines to remove the roots and leaves that remain after field harvesting. Other crops, particularly lettuce and the like that are of a “softer,” more easily damaged nature, typically do not have the remaining waste portions of the crop removed by machine. Instead, the waste portions of the crop remaining attached to the produce portion after harvesting are removed by hand by the field workers so as to minimize damage to and loss of the produce (i.e., the marketable) portion of the crop.

One common type of lettuce is Romaine lettuce. Romaine lettuce is a generally cylindrically-shaped crop that has the plant portion grown on top of the ground and the roots grown below the ground. The plant portion has an upper or top section consisting primarily of leaves and leafy matter (referred to as the “top”) and a lower section (referred to as the “tail”) that has the plant core or stem. The primary useful, produce section of romaine lettuce is the middle section of the plant (i.e., that part between the upper leafy material top section and the lower tail section). The core of a romaine lettuce plant is a stalk-like, cone-shaped portion of the plant that extends upward from the bottom of the plant into its center. In the typical harvesting procedure, the above-ground plant is separated from its below ground root system, extracted from the field and placed on the cutting table of a specially designed harvesting machine. After extraction, the tops and tails are cut off and the produce section of the plant is prepared for storage and, ultimately, for delivery to the consumer.

As is well known, harvesting Romaine lettuce is a very labor intensive process requiring a significant number of workers to extract the crop from the field and then separate the produce section of the crop from the tops and tails of the plant. Although mechanical harvesters for harvesting Romaine lettuce have been in use for a number of years, the removal of the tops and tails from the produce section of the plant is something that has not been able to be delegated to the mechanical harvester. Typically, a knife having a long, straight cutting edge and a handle (similar in configuration to a small machete) is used to cut the tops and tails from the produce. Removing the tops and tails is not adaptable to a machine because not all Romaine lettuce plants, that portion that grows above the ground, are the same size and the top and tail sections to be cut off are not the same length. It takes a worker with an experienced eye to cut the tops and tails away from the produce so as to maximize the amount of high quality produce that is harvested. A poorly cut plant will result in too much waste material remaining attached to the produce section, which is not desirable from a marketing aspect, or will result in an undesirable amount of produce ending up in the waste material.

Even the most experience field worker results in more waste than is normally desirable due to the configuration of the tail section of the plant and the knife used to cut away waste. The tail section of Romaine lettuce has a center, bottom core portion that is generally cone shaped. Although the material around the cone above the bottom of the plant is useful produce, the typical cutting procedure is to cut across the plant at approximately the tip of the cone with the straight edge knife, as described in more detail below. This results in the produce portion around the core becoming waste material. The field worker could use the knife to make two cuts in the form of an inverted “V” to remove the core from the tail and, thereby, save the produce portion of the tail section from ending up as waste material. This would, however, substantially increase the amount of time it takes the worker to trim each plant that he or she has to handle. Because the lettuce is moved across the harvesting table by way of a conveyor belt, the additional amount of time it would take to cut the plant in this manner prevents this procedure from being a generally acceptable harvesting practice. In addition, the handling necessary to make the inverted “V” cuts would also substantially increase the likelihood of cutting injuries to the field workers. Due to the high cost associated with the time it takes to make the necessary cuts, the potential loss of personnel from injuries and the likelihood of increased workers compensation liability, virtually no one in the industry attempts to fully maximize the production of Romaine lettuce by preventing the produce portion of the tail section from being included with the waste portion when it is separated from the produce section of the plant and discarded.

It can be appreciated, therefore, that what is needed is an improved device for cutting produce, particularly Romaine lettuce and similarly configured crops, that effectively and efficiently allows the field worker to separate the useful produce portion of the plant from the waste portion of the plant. The desired cutting device must be easily held and manipulated by the field worker so as to cut away the tops and tails of the plant in a manner that separates the tail section of the plant from the produce section of the plant without increasing the amount of time it takes to make such cuts or increase the risk of injury to the worker. The desirable cutting device should be a knife that is shaped and configured to be able to cut the top section away from the produce section and to cut the cone-shaped core (waste) portion from the tail section of the plant, thereby leaving a greater amount of produce to take to market.

### SUMMARY OF THE INVENTION

The v-cut knife for cutting crops of the present invention solves the problems and provides the benefits identified above. That is to say, the present invention provides a crop cutting knife that is useful for cutting away the waste portions of the plant so as to maximize the produce portion of the plant without increasing the amount of time for such cutting or the likelihood of injury to the field worker. The v-cut knife of the present invention is particularly suited for cutting the tops and tails of Romaine lettuce in a manner that increases the amount of the useful, produce portion of the plant remaining for market. In more particularity, the v-cut knife of the present invention allows the field worker to easily, quickly and safely cut away the generally cylindrical-shaped core of the tail section of the plant from the produce portion in the tail section

In the primary embodiment of the present invention, the v-cut knife of the present invention primarily comprises a handle and a blade section connected to the handle. The blade section has a generally elongated blade with a proximal end, a distal end, a top side and a bottom side. The bottom side of the blade should be configured into a sharp cutting edge for cutting through the crop to separate the waste portion of the crop from the produce portion of the crop. A generally v-shaped portion is located in the blade section between the proximal end and the distal end of the blade, preferably toward the proximal end of the blade (i.e., that end nearest the handle). The v-shaped section is shaped and configured to efficiently, quickly and safely cut the waste portion away from the produce portion of the crop. The length of the handle should be sufficiently long to allow a worker's hand to comfortably grip the handle and, preferably be configured to have finger gripping portions thereon. To allow the user of the knife to provide more force, if necessary, the top side of the blade can have a substantially flat, wide surface (at least relative to the bottom side of the blade) thereon. Depending on the crop with which the knife is to be used, the v-shaped section should be configured to generally match the characteristics of the plant. For instance, with Romaine lettuce, the blade should be 7 to 12 inches long, the v-shaped section should have an interior angle of approximately 75 degrees to 110 degrees and the v-shaped section should be made up of a first section that is approximately 1 inch to 3 inches long and a second section that is approximately 1 inch to 3 inches long.

The method of using the above-described knife has the steps of holding the crop on a cutting surface (such as that typically provided with the harvesting machine), positioning the knife above the crop so that the v-shaped section of the knife is in general alignment with the intersection of the waste portion and the produce portion of the crop, lowering the knife to the crop and forcing the v-shaped section of the knife through the crop so as to separate the waste portion of the crop away from the produce portion of the crop. In the preferred method, the steps of lowering the knife and forcing the v-shaped section of the knife through the crop are performed in a single, quick motion. For those crops, such as Romaine lettuce, that have more than one section of the crop having waste material, the portion of the blade extending beyond the v-shaped section can be used to cut the other waste section of the crop before positioning the v-shaped section above the crop or it can be done after the waste portion is separated from the produce portion of the crop.

Accordingly, the primary objective of the present invention is to provide a v-cut knife for cutting away the waste portion of a crop from the produce portion of the crop having the features generally described above and more specifically described below in the detailed description.

It is also an important objective of the present invention to provide a v-cut knife that effectively and efficiently cuts the waste portion of a crop from the produce portion of the crop without requiring more cutting time or increasing the likelihood of injury to the field worker.

It is also an important objective of the present invention to provide a v-cut knife that is particularly suited for cutting away the core portion from the produce portion of the tail section of Romaine lettuce.

It is also an important objective of the present invention to provide a v-cut knife that comprises a handle and a blade section, wherein the blade section further comprises a knife blade having a v-shaped section disposed between the proximal and distal ends of the blade and a cutting edge on the bottom side of the blade for cutting away the waste portion of a plant from the produce portion of the plant.

Yet another important objective of the present invention is to provide a method of utilizing a v-cut knife for cutting away the waste portion of a crop from the produce portion of the crop so as to maximize the amount of produce without increasing the amount of time for cutting or the risk of injury from the cutting procedure.

The above and other objectives of the present invention will be explained in greater detail by reference to the attached figures and the description of the preferred embodiment which follows. As set forth herein, the present invention resides in the novel features of form, construction, mode of operation and combination of parts presently described and understood by the claims.

### BRIEF DESCRIPTION OF THE DRAWINGS

In the drawings which illustrate the best modes presently contemplated for carrying out the present invention:

FIG. 1 is a side view of the plant portion of a Romaine lettuce crop that can be cut by the v-cut knife of the present invention showing the various sections of the plant;

FIG. 2 is a top plan view of the v-cut knife for cutting crops of the present invention; and

FIG. 3 is side view of the v-cut knife of the present invention.

### DETAILED DESCRIPTION OF THE PREFERRED EMBODIMENTS

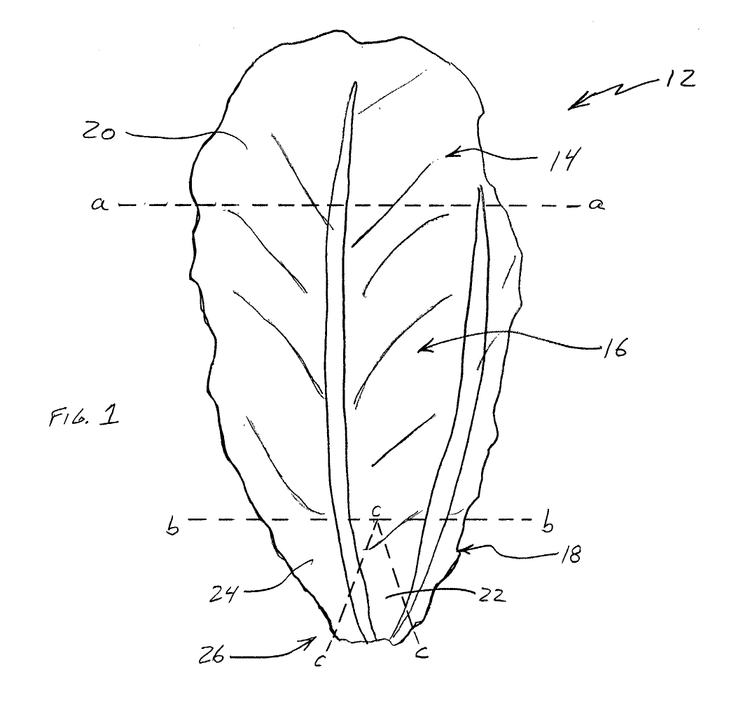

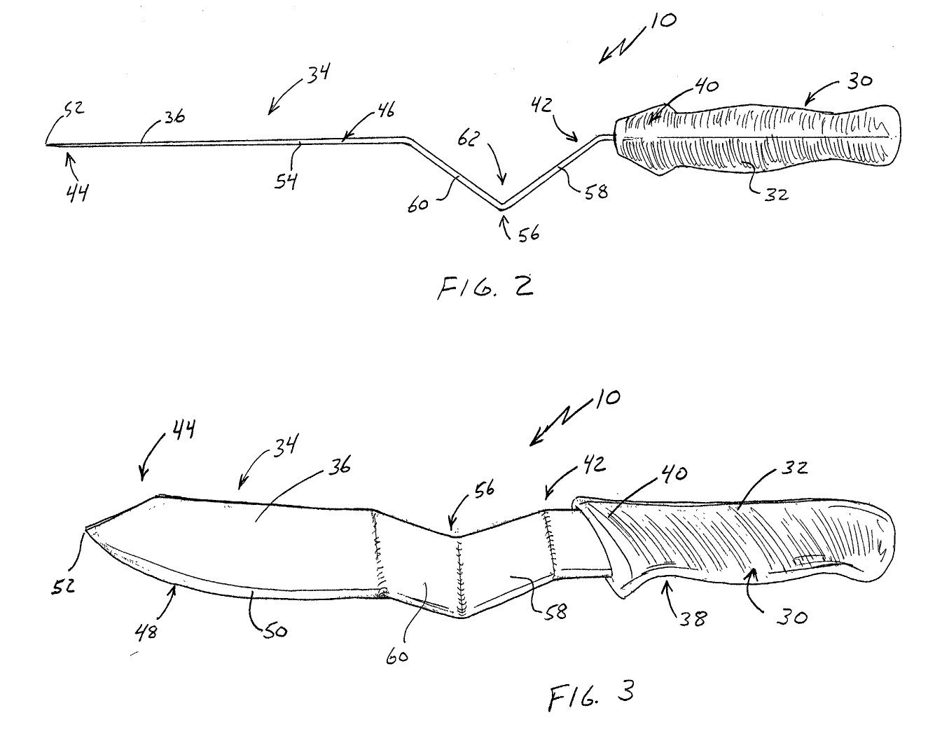

With reference to the figures where like elements have been given like numerical designations to facilitate the reader's understanding of the present invention, and particularly with reference to the embodiment of the present invention illustrated in the referenced figures, the preferred embodiments of the present invention are set forth below. The v-cut knife of the present invention, designated generally as 10 in FIGS. 2 and 3, is useful for cutting the waste portion of a crop away from the useful, produce section of the crop. One such crop that knife 10 of the present invention is particularly useful for is Romaine lettuce. As shown in FIG. 1, the plant portion 12 of Romaine lettuce generally comprises a top section 14, produce section 16 and tail section 18. The top section 14 is primarily comprised of leaves and leafy material 20 that is generally not desirable to the consumer. The produce section 16 is that part of plant 12 that is the most desirable portion for the consumer and which is used in making salads, soups and other dishes. During the typical harvesting process, the top 14 and tail 18 sections are cut (at lines a-a and b-b, respectively) away from the produce section 16 and discarded as waste (i.e., that portion of plant 12 that is not desirable to the typical consumer for human consumption).

As shown in FIG. 1, tail section 18 comprises a generally cone-shaped core portion 22 (defined by lines c-c) and a produce portion 24 that surrounds core portion 22 at the bottom 26 of plant 12. Core portion 22 comprises the center core of plant 12 and is considered waste. Although produce portion 24 is comprised of edible plant material that is similar to that which is found in produce section 16, it is nevertheless generally discarded with tail section 18 due to the standard harvesting procedures. As set forth above, the field workers who trim plant 12 after it is extracted from the field utilize a generally straight, machete-type knife to cut the top section 14 at line a-a and the tail section 18 at line b-b to separate the produce section 16 from the waste material of the top 14 and tail 18 sections. As a result, produce portion 24 of tail section 18 is generally also considered waste material. To increase the amount of marketable crop, the workers could make a generally v-shaped cut (as represented by lines c-c) at the bottom 26 of plant 12 to cut around core portion 22, thereby leaving produce portion 24 attached to produce section 16. However, as explained above, this process would increase the amount of time necessary to handle each plant 12 and increase the risk of injury to the worker from having to manipulate plant 12 so as to make the cuts at lines c-c. Generally, most Romaine lettuce producers do not consider the benefit of the increased crop production to be worth the cost and risks of making the v-shaped cuts so as to preserve the relatively small produce portion 24 (which, however, can be a very substantial amount of produce when harvesting a large field).

The v-cut knife 10 of the present invention allows the field worker to quickly, easily and safely make the desired cut so as to increase the amount of crop produced for market. In the preferred embodiment, as shown in FIGS. 2 and 3, knife 10 comprises a handle section 30 having handle 32 and a blade section 34 having a generally elongated blade 36. As is well known in the art, handle section 30 and blade section 34 are configured such that handle 32 is joined together with blade 36 to form a single unit. The preferred mechanism to join handle 32 and blade 36 is to place a portion of blade section 34 inside handle 32 such that handle 32 is bonded to and around that portion of the blade section 34, as is done with the prior art machete-type knives. In some configurations, handle 32 is a plastic or plastic-type material that is molded around a portion of blade section 34 to join the two sections together. In the preferred embodiment, handle 32 is sufficiently long to allow a worker's entire hand to comfortably grip the handle 32 during harvesting operations. For instance, a handle length of four to six inches has been found to be of sufficient length to allow most persons to safely and comfortably grip handle 32. Also, as known in the art, it is preferable that handle 32 be shaped and configured to further allow the worker to safely and comfortably grip handle 32. For instance, handle 32 can include one or more finger grips, shown generally as 38 in FIG. 3, on the bottom of handle 32 and an enlarged section 40 at the end of handle 32 nearest blade 36 to provide better gripping and prevent the user's hand from sliding onto blade 36. Handle 32 can be made out of plastic, composites, wood, metal or a variety of other materials. Generally, the preferred materials are those that are at least slightly pliable for gripping or have the ability to reduce the shock impact resulting from hitting knife 10 against a flat surface (i.e., the cutting table).

Blade 36 has a proximal end 42 at the junction of blade 36 and handle 32, a distal end 44 opposite of proximal end 42, a top side 46 and a 5 bottom side 48 opposite top side 46 (the top and bottom designations being relative to the cutting action of knife 10 when used as described herein to cut plant 12). As is known in the art, bottom side 48 is shaped and configured to form a cutting edge 50 for blade 36. Although different configurations are possible, in the preferred embodiment, cutting edge 50 is provided along the entire length of blade 36 from its proximal end 42 to its distal end 44 so that the entire blade 36 is useful for cutting crops, as set forth in more detail below. Also in the preferred embodiment, as best shown in FIG. 3, the top side 46 and bottom side 48 converge into a pointed end 52 at distal end 44. The top side 46 can have a generally flat, wide surface 54 (relative to cutting edge 50) that is not sharp to reduce the likelihood of injuries. In addition, the worker can use flat surface 54 to press downward against blade 36 when extra force is necessary to cut through the tail section 18 of plant 12 to form the cuts described herein. As an example, flat surface can be approximately one-eighth to one-half an inch wide to provide the benefits described above. Various materials can be used to form blade 36, however, metals such as stainless steel are preferred due to the ability to form such metals into the desired configuration and sharpness for knife 10 and the ability to sanitize blade 36 as required for cutting food crops. The desired material for blade 36 should be able to be sharped to a fine cutting edge 50 and maintain that sharpness for a reasonable amount of use. Preferably, the material for blade 36 should also be suitable for sharpening as needed.

The v-cut knife 10 of the present invention also includes a generally v-shaped section 56 for cutting the tail section 18 of plant 12 at lines c-c to remove the undesirable, waste core portion 22 and leave the produce portion 24 behind. As best shown in FIG. 2, v-shaped section 56 is shaped to generally match the shape of the typical core portion 22 so the core portion 22 can be removed in a single cutting action. V-shaped section 56 is formed of two bent sections of blade 36, first section 58 and second section 60, with an interior angle 62 therebetween (best shown in FIG. 2). As with the remaining portions of blade 36, the bottom side 48 of v-shaped section 56 is formed into a sharp cutting edge 50 to be able to slice through the tail section 18 with relative ease. While it is strongly preferred that blade 36 and v-shaped section 56 be integral and formed from the same material (i.e., by merely “bending” blade 36 to the desired shape and configuration), blade 36 and v-shaped section 56 can be separate components that are joined together by welding, adhesives, connectors or other mechanisms of joining two such components together. Due to the use of knife 10, as explained further below, blade 36 with v-shaped section 56 will be hit against a cutting surface to slice off the top 14 and tail 16 sections. If separate components are utilized, they must be joined together sufficiently well for the combined components to maintain their integrity during the hitting action against the cutting surface so as to avoid damaging the knife 10 and injuring workers.

A number of configurations for blade 36 and v-shaped section 56 are possible depending on the crop with which it is desired to utilize knife 10. For some crops it may be desirable to have more or less blade 36 extending beyond v-shaped section 36, have v-shaped section 56 located closer to distal end 44 than proximal end 42 or have different interior angle 62. The preferred characteristics of blade 36 and v-shaped section 56 will depend on the size, shape and other characteristics of the crop to be trimmed. For Romaine lettuce, the inventors have found that a blade 36 of seven to twelve inches long having a v-shaped section 56 comprised of first 58 and second 60 sections one to four inches long with an interior angle of approximately 75 to 110 degrees is typically sufficient to accomplish the task described below. In one embodiment, the inventors have utilized a blade 36 that is approximately nine inches from proximal end 42 to distal end 44 (at point 52) having first 58 and second 60 sections approximately one and three-fourths inches long with an interior angle of approximately 95 degrees generally performs well. The knife 10 of the present invention can be made in multiple sizes (i.e., a small, medium and large size) to accommodate various sizes of Romaine lettuce. The small size can have a first 58 and second 60 section of one-half to two inches, the medium can have a first 58 and second 60 section length of two to three inches and the large size can have a first 58 and second 60 section of three to four inches in length. The width of flat surface 54 will also be dependent upon the difficulty a worker typically experiences in trying to cut the waste portion (i.e., core portion 22) from the produce portion 24 of the plant 12. The more difficult it is to cut, slice or chop through the plant, the wider it may be necessary to make flat surface 54.

In use, the plant 12 is extracted from the field, either by hand or by a harvesting machine, and the plant 12 is delivered to a worker at a cutting table for trimming the waste material from the portion of the plant to be marketed. The worker holds plant 12 by one of its ends while utilizing the knife 10 of the present invention to trim the waste from the opposite end. For instance, the worker could first hold the top section 14 of plant 12 with his or her free hand while utilizing knife 10 to cut the core portion 22 from tail section 18 and then use his or her free hand to hold the remaining part of tail section 18 to cut the top section 14 away from produce section 16. As stated above, when using the prior art machete-type knives, the worker would merely cut the plant 12 at lines a-a and b-b to cut away the top section 14 and tail section 18, respectively, from the produce section 16. Cutting away the entire tail section 18 results in the loss, as waste material, of the marketable produce portion 24 surrounding the core portion 22, which is necessarily waste. Over an entire field of Romaine lettuce, for instance, this can result in the loss of a significant amount of produce that could be otherwise sold (typically by weight). Heretofore, it has not been practical to isolate and recover this wasted produce portion 24 of plant 12.

With knife 10 of the present invention, the worker will merely hold the end of plant 12 having or which had the top section 14 with his or her free hand while holding the knife in the other hand. The worker will then position the v-shaped section 56 above the intersection of the waste portion 22 and the produce portion 24 of plant 12, along lines c-c. The worker will lower the knife 10 to plant 12 and, preferably, with a single chopping motion force knife 10 through the tail section 18 of plant 12 at its bottom 26 to cut out the core portion, as represented by lines c-c. The single preferred chopping action takes no more time and is generally no more dangerous than cutting, slicing or chopping plant 12 at lines b-b to remove the entire tail section 18. In the single chopping action the core portion 22 is separated from the tail section 18 of plant 12, leaving the marketable produce portion 24 of tail section 18 attached to produce section 16. If necessary, the worker can place his or her free hand on the flat, wider top side 54 of top side 46 of blade 36 to push down on blade 36 so as to help force v-shaped section 56 through the tail section 18. The portion of blade 36 that extends beyond the v-shaped section 56 is used to cut, slice or chop off the top section 14, as was done in the prior art. Preferably, the tail section 18 is cut while the top section 14 remains intact to provide more material for gripping plant 12 while cutting tail section 18.

From the forgoing description it will be apparent that there is provided a knife for cutting crops to remove the waste portion of the crop from the produce portion while minimizing the amount of the produce portion that ends up as waste material without sacrificing efficiency and safety. While there is shown and described herein certain specific alternative forms of the invention, it will be readily apparent to those skilled in the art that the invention is not so limited, but is susceptible to various modifications and rearrangements in design and materials without departing from the spirit and scope of the invention. In particular, it should be noted that the present invention is subject to modification with regard to the dimensional relationships set forth herein and modifications in assembly, materials, size, shape, and use. Accordingly, the foregoing description should be taken as illustrative and not in a limiting sense.

What is claimed is:

1. A knife for cutting a waste portion of a crop from the produce portion of the crop, the knife comprising:
a handle;
a blade section connected to said handle, said blade section comprising a generally elongated blade having a proximal end, a distal end, a top side and a bottom side, said bottom side configured into a sharp cutting edge; and
a generally v-shaped portion formed in said blade section between said proximal end and said distal end of said blade, said v-shaped section shaped and configured to cut the waste portion away from the produce portion of the crop.

2. The knife according to claim 1, wherein the length of said handle is sufficiently long to allow a worker's hand to comfortably grip said handle.

3. The knife according to claim 2, wherein said handle section is configured to have finger gripping portions thereon.

4. The knife according to claim 1, wherein said top side of said blade is a substantially flat, wide surface relative to said bottom side of said blade.

5. The knife according to claim 1, wherein said distal end of said blade converges into a pointed end.

6. The knife according to claim 1, wherein said handle is affixed to said blade section at said proximal end of said blade.

7. The knife according to claim 1, wherein said v-shaped section is disposed near said proximal end of said blade.

8. The knife according to claim 1, wherein said v-shaped section comprises an interior angle of approximately 75 degrees to 110 degrees.

9. The knife according to claim 1, wherein said blade is 7 to 12 inches long.

10. The knife according to claim 1, wherein said v-shaped section comprises a first section approximately 1 inch to 4 inches long and a second section approximately 1 inch to 4 inches long.

11. The knife according to claim 10, wherein said v-shaped section comprises an interior angle of approximately 75 degrees to 110 degrees and said blade is 7 to 12 inches long.

12. A knife for cutting a waste portion of a crop from the produce portion of the crop, the knife comprising:
an elongated handle, the length of said handle being sufficiently long to allow a worker's hand to comfortably grip said handle;
a blade section connected to said handle, said blade section comprising a generally elongated blade having a proximal end, a distal end, a top side and a bottom side, said bottom side configured into a sharp cutting edge, said blade having a length of 7 to 12 inches; and
a generally v-shaped portion formed in said blade section between said proximal end and said distal end of said blade, said v-shaped section disposed near said proximal end of said blade and comprising an interior angle of approximately 75 degrees to 110 degrees, said v-shaped section shaped and configured to cut the waste portion away from the produce portion of the crop.

13. The knife according to claim 12, wherein said top side of said blade is a substantially flat, wide surface relative to said bottom side of said blade.

14. The knife according to claim 12, wherein said v-shaped section comprises a first section approximately 1 inch to 4 inches long and a second section approximately 1 inch to 4 inches long.

15. A method of cutting away a waste portion of a crop from a produce portion of said crop utilizing a knife having a handle, a generally elongated blade attached to said handle, a generally v-shaped section formed in said blade and a portion of said blade extending beyond said v-shaped section, said blade having a bottom side configured into a sharp cutting edge, said method comprising the steps of:
a. holding said crop on a cutting surface;
b. positioning said knife above said crop, said v-shaped section of said knife in general alignment with said intersection of said waste portion and said produce portion of said crop;
c. lowering said knife to said crop; and
d. forcing said v-shaped section of said knife through said crop so as to separate said waste portion of said crop away from said produce portion of said crop.

16. The method of claim 15, wherein said steps of lowering said knife and forcing said v-shaped section of said knife through said crop are performed in a single motion.

17. The method of claim 15 further comprising the step of utilizing said portion of said blade extending beyond said v-shaped section to cut another section said crop before said positioning step.

18. The method of claim 15 further comprising the step of utilizing said portion of said blade extending beyond said v-shaped section to cut another section said crop after said forcing step.
